(19) United States
(12) Patent Application Publication
(10) Pub. No.: US 2026/0362261 A1
(43) Pub. Date: Nov. 12, 2026

(54) LAYER 3 AND LAYER 1 PROCEDURE ENHANCEMENT FOR SCELL ACTIVATION

(71) Applicant: Apple Inc., Cupertino, CA (US)

(72) Inventors: Qiming Li, Beijing (CN); Jie Cui, San Jose, CA (US); Yang Tang, San Jose, CA (US); Rolando E. Bettancourt Ortega, Munich (DE); Xiang Chen, Palo Alto, CA (US); Manasa Raghavan, Sunnyvale, CA (US); Yuexia Song, Beijing (CN); Dawei Zhang, Saratoga, CA (US); Hong He; Qunfeng He, San Diego, CA (US)

(21) Appl. No.: 18/997,009

(22) PCT Filed: Aug. 3, 2022
(86) PCT No.: PCT/CN2022/109924

§ 371 Date: Jan. 18, 2025

(51) Int. Cl. H04W 36/00; H04B 17/318; H04L 5/00

(52) U.S. Cl. CPC H04W 36/00835; H04B 17/328; H04L 5/0098

(57) ABSTRACT

The disclosure relates to layer 3 (L3) and layer 1 (L1) procedure enhancement for Secondary Cell (SCell) activation. In some embodiments, there is provided a user equipment (UE), comprising at least one antenna, at least one radio coupled to the at least one antenna and a processor coupled to the at least one radio. The processor is configured to transmit to a network a capability indicator that indicates that the UE can support a shorten SCell activation period, and perform an enhanced L3 and/or L1 procedure during an SCell activation period.

### TECHNICAL FIELD

This application relates generally to wireless communication systems, including user equipments (UEs), base stations (BSs), methods, apparatus, and medium for layer 3 (L3) and layer 1 (L1) procedure enhancement for Secondary Cell (SCell) activation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to user equipments, base stations, methods, apparatus, and medium for L3 and L1 procedure enhancement for SCell activation.

In one aspect, there is provided a user equipment (UE), comprising at least one antenna, at least one radio coupled to the at least one antenna and a processor coupled to the at least one radio. The processor is configured to: transmit, to a network, a capability indicator that indicates that the UE can support a shorten SCell activation period; and perform an enhanced L3 and/or L1 procedure during an SCell activation period.

In another aspect, there is provided a method, comprising: by a user equipment (UE), transmitting to a network a capability indicator that indicates that the UE can support a shorten Secondary Cell (SCell) activation period; and performing an enhanced Layer 3 (L3) and/or Layer 1 (L1) procedure during an SCell activation period.

In another aspect, there is provided an apparatus for operating a user equipment (UE), comprising: a processor configured to cause the UE to perform a method as recited above.

In another aspect, there is provided a non-transitory computer-readable memory medium storing program instructions which, when executed at a user equipment (UE), cause the UE to perform a method as recited above.

In another aspect, there is provided a base station (BS), comprising at least one antenna, at least one radio coupled to the at least one antenna, and a processor coupled to the at least one radio. The processor is configured to: receive from a UE a capability indicator that indicates that the UE can support a shorten Secondary Cell (SCell) activation period by performing enhancement on Layer 3 (L3) and/or Layer 1 (L1) procedure during an SCell activation period; and adjust an operation during the SCell activation period based on the capability indicator.

In another aspect, there is provided a method, comprising: by a base station (BS) receiving from a UE a capability indicator that indicates that the UE can support a shorten Secondary Cell (SCell) activation period by performing enhancement on Layer 3 (L3) and/or Layer 1 (L1) procedure during an SCell activation period; and adjusting an operation during the SCell activation period based on the capability indicator.

In another aspect, there is provided an apparatus for operating a base station (BS), comprising a processor configured to cause the BS to perform a method as recited above.

In another aspect, there is provided a non-transitory computer-readable memory medium storing program instructions which, when executed at a base station (BS), cause the BS to perform a method as recited above.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example classification for existing FR2 SCell activation scenarios.

FIG. 4 illustrates an example SCell activation period for case 2-2-1.

FIG. 5 illustrates an example flowchart of a method performed by a UE, according to embodiments disclosed herein.

FIG. 6 illustrates an example flowchart of a method performed by a UE for enhancement on L3 procedure for SCell activation, according to embodiments disclosed herein.

FIG. 7A illustrates an example flowchart of a method performed by a UE for enhancement on L3 procedure for SCell activation, according to embodiments disclosed herein.

FIG. 7B shows an example SCell activation period affected by an enhanced beam sweeping factor, according to embodiments disclosed herein.

FIG. 8A illustrates an example flowchart of a method performed by a UE for enhancement on L3 procedure for SCell activation, according to embodiments disclosed herein.

FIG. 8B shows an example SCell activation period affected by an enhanced physical layer filtering factor, according to embodiments disclosed herein.

FIG. 9A illustrates an example flowchart of a method performed by a UE for enhancement on L3 procedure for SCell activation, according to embodiments disclosed herein.

FIG. 9B shows an example SCell activation period affected by applying timing from cell synchronization to Layer 1-Reference Signal Receiving Power (L1-RSRP) measurement, according to embodiments disclosed herein.

FIG. 10A illustrates an example flowchart of a method performed by a UE for enhancement on L1 procedure for SCell activation, according to embodiments disclosed herein.

FIG. 10B illustrates an example flowchart of a method performed by a UE for enhancement on L1 procedure for SCell activation, according to embodiments disclosed herein.

FIG. 10C shows an example SCell activation period affected by enhancement on L1-RSRP/beam measurement, according to embodiments disclosed herein.

FIG. 11A illustrates an example flowchart of a method performed by a UE for enhancement on L1 procedure for SCell activation, according to embodiments disclosed herein.

FIG. 11B shows an example SCell activation period affected by timing tracking enhancement on (Transmission Configuration Indicator TCI), according to embodiments disclosed herein.

FIG. 12 illustrates an example flowchart of a method performed by a base station, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

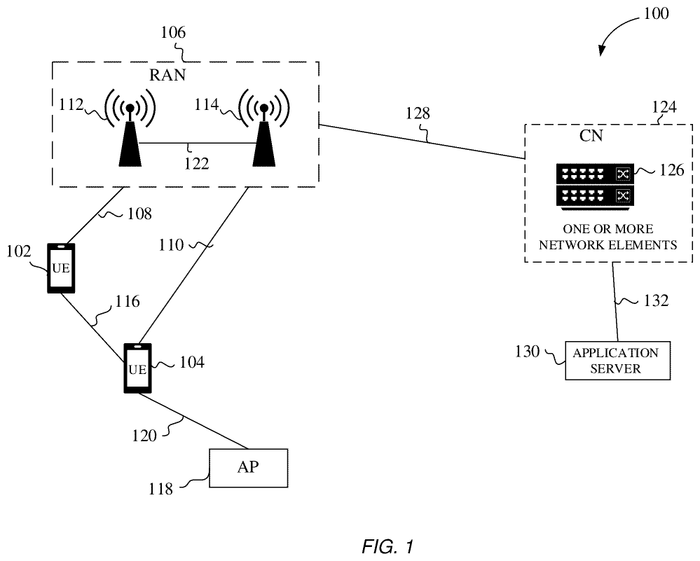

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR. In a case that the RAN 106 is an NTN-based NG-RAN architecture, the connection 108 and connection 110 are NR Uu interfaces.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

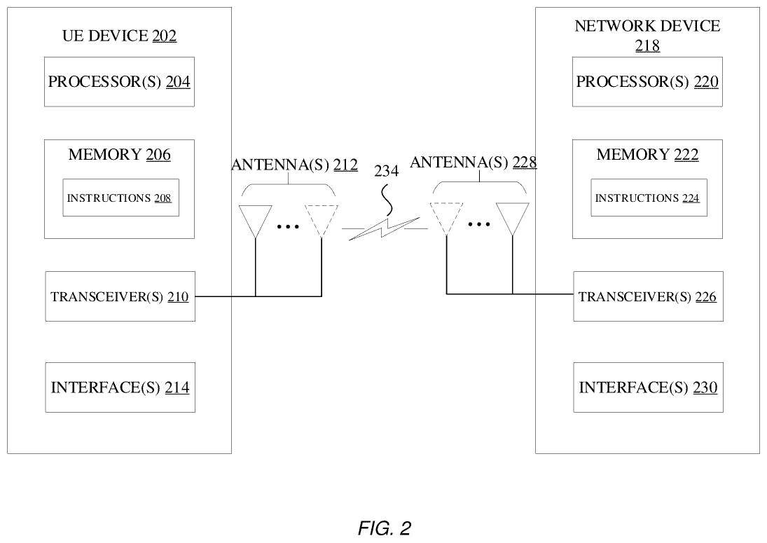

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The disclosure here considers FR2 SCell activation delay reduction.

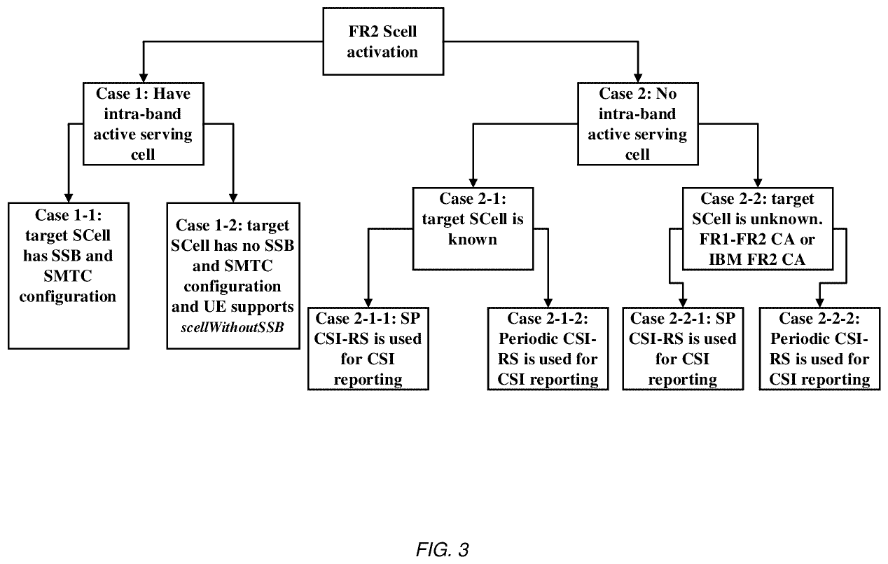

FIG. 3 illustrates an example classification for existing FR2 SCell activation scenarios.

According to Section 8.3.2 in 3GPP TS 38.133 V17.6.0 (2022-06), existing FR2 SCell activation scenarios may be classified into: Case 1 in which the SCell being activated belongs to FR2 and there is at least one active serving cell on that FR2 band; or Case 2 in which the SCell being activated belongs to FR2 and there is no active serving cell on that FR2 band.

Existing FR2 SCell activation scenarios in Case 1 can be further classified into: Case 1-1 in which the UE has SSB and SS/PBCH block measurement timing configuration (SMTC) configuration; or case 1-2 in which the UE has no SSB/SMTC configuration and supports scellWithoutSSB.

Existing FR2 SCell activation scenarios in Case 2 can be further classified into: Case 2-1 in which the target SCell is known to UE; or Case 2-2 in which the target SCell is unknown to the UE and the PCell/PSCell and the target SCell are configured as FR1-FR2 Carrier Aggregation (CA) or if the PCell/PSCell and the target SCell are in a FR2 band pair with independent beam management.

Existing FR2 SCell activation scenarios in Case 2-1 can be further classified into: Case 2-1-1 in which semi-persistent (SP) CSI-RS is used for CSI reporting; or Case 2-1-2 in which periodic CSI-RS is used for CSI reporting.

Existing FR2 SCell activation scenarios in Case 2-2 can be further classified into: Case 2-2-1 in which semi-persistent CSI-RS is used for CSI reporting; or Case 2-2-2 in which periodic CSI-RS is used for CSI reporting.

Table 1 shows requirements for T_{activation_time} for all these cases shown in FIG. 3. T_{activation_time} is the SCell activation delay in millisecond, from decoding of a MAC CE for SCell activation to the reporting of CSI.

TABLE 1

| Case ID | requirements for T_{activation}_{_{—}}ₜᵢₘₑ |
|---|---|
| Case 1-1 | T_{FirstSSB} + 5 ms |
| Case 1-2 | 3 ms |
| Case 2-1-1 | 3 ms + max(T_{uncertainty}_{_{—}}_{MAC} + T_{FineTiming} + 2 ms, T_{uncertainty}_{_{—}}_{SP}) |
| Case 2-1-2 | max (T_{uncertainty}_{_{—}}_{MAC} + 5 ms + T_{FineTiming}, T_{uncertainty}_{_{—}}_{RRC} + T_{RRC}_{_{—}}_{delay} − T_{HARQ}) |
| Case 2-2-1 | 6 ms + T_{FirstSSB}_{_{—}}_{MAX} + 15*T_{SMTC}_{_{—}}_{MAX} + 8*Tᵣₛ + T_{L1-RSRP, measure} + T_{L1-RSRP, report} + |
| | T_{HARQ} + max(T_{uncertainty}_{_{—}}_{MAC} + T_{FineTiming} + 2 ms, T_{uncertainty}_{_{—}}_{SP}) |
| Case 2-2-2 | 3 ms + T_{FirstSSB}_{_{—}}_{MAX} + 15*T_{SMTC}_{_{—}}_{MAX} + 8*Tᵣₛ + T_{L1-RSRP, measure} + T_{L1-RSRP, report} + |
| | max {(T_{HARQ} + T_{uncertainty}_{_{—}}_{MAC} + 5 ms + T_{FineTiming}), (T_{uncertainty}_{_{—}}_{RRC} + |
| | T_{RRC}_{_{—}}_{delay})}. |

For example, for Case 1-1, T_{activation_time} is T_{FirstSSB}+5 ms, wherein T_{FirstSSB} may be the time to the end of the first complete SSB burst indicated by the SMTC, or within 5 ms if SMTC is not configured.

For case 2-2-1, T_{activation_time} is 6 ms+T_{FirstSSB_MAX}+15*T_{SMTC_MAX}+8*Tᵣₛ+T_{L1-RSRP, measure}+T_{L1-RSRP, report}+T_{HARQ}+max(T_{uncertainty_MAC}+T_{FineTiming}+2 ms, T_{uncertainty_SP}).

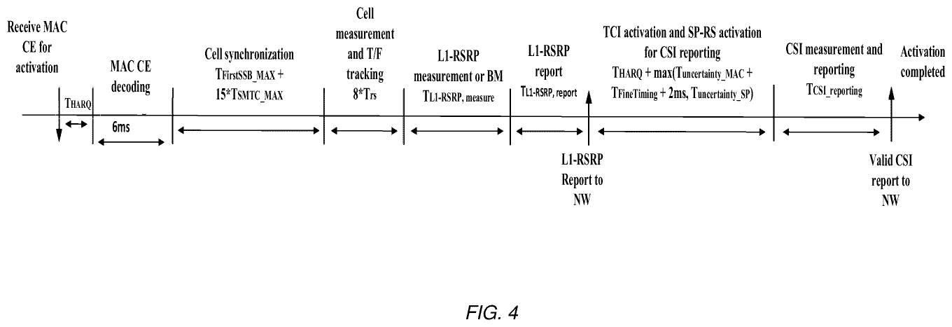

FIG. 4 illustrates an example SCell activation period for case 2-2-1.

As shown in FIG. 4, the SCell activation period includes a plurality of working parts, such as HARQ, MAC CE decoding, cell synchronization, cell measurement and T/F tracking, L1-RSRP measurement or beam measurement (BM), L1-RSRP report, TCI activation and SP-RS activation, CSI measurement and reporting.

As shown in FIG. 4, the SCell activation period starts upon receipt of MAC CE for the SCell activation, then includes a time period T_{HARQ} (in ms) which may be the timing between DL data transmission and acknowledgement.

Then, the cell synchronization is performed, and the time period related with the cell synchronization is T_{FirstSSB_MAX}+15*T_{SMTC_MAX}, wherein T_{FirstSSB_MAX} may be the time to the end of the first complete SSB burst indicated by the SMTC, or within 5 ms if SMTC is not configured, when all active serving cells and SCells being activated or released are transmitting SSB bursts in the same slot.

Following that, cell measurement and Time/Frequency tracking is performed and a corresponding time period is 8*Tᵣₛ, wherein Tᵣₛ may be a time related with SMTC configuration.

After that, L1-RSRP measurement or beam measurement is performed to determine the best beam, and a corresponding time period is T_{L1-RSRP, measure} which may be the L1-RSRP measurement delay.

Then, L1-RSRP report is performed to report to the network the best beam and the completion of L1-RSRP measurement or beam measurement, and a corresponding time period is T_{L1-RSRP, report} which may be delay of acquiring CSI reporting resources.

After that, the network schedules Transmission Configuration Indicator (TCI) and Semi-persist Reference Signals (SP RS) for the UE. TCI activation and SP-RS activation for Channel State Information (CSI) reporting is performed, and a corresponding time period is T_{HARQ}+max(T_{uncertainty_MAC}+T_{FineTiming}+2 ms, T_{uncertainty_SP}). T_{uncertainty_MAC} may be the time period between reception of the last activation command for Physical Downlink Control Channel (PDCCH) TCI, Physical Downlink Shared CHannel (PDSCH) TCI (when applicable) relative to SCell activation command for known case or first valid L1-RSRP reporting for unknown case. T_{FineTiming} may be the time period between UE finish processing the last activation command for PDCCH TCI, PDSCH TCI (when applicable) and the timing of first complete available SSB corresponding to the TCI state. T_{uncertainty_SP} may be the time period between reception of the activation command for semi-persistent CSI-RS resource set for CQI reporting relative to SCell activation command for known case, or first valid L1-RSRP reporting for unknown case.

For case 2-1-2, T_{activation_time} is 3 ms+T_{FirstSSB_MAX}+15*T_{SMTC_MAX}+8*Tᵣₛ+T_{L1-RSRP, measure}+T_{L1-RSRP, report}+max {(T_{HARQ}+T_{uncertainty_MAC}+5 ms+T_{FineTiming}), (T_{uncertainty_RRC}+T_{RRC_delay})}. T_{uncertainty_RRC} may be the time period between reception of the RRC configuration message for TCI of periodic CSI-RS for CQI reporting (when applicable) relative to SCell activation command for known case, or first valid L1-RSRP reporting for unknown case. T_{RRC_delay} is the RRC procedure delay.

### Overview

The disclosure considers FR2 SCell activation enhancement.

In one aspect, a new UE capability signaling is designed for indicating to the network that the UE can support L3 and/or L1 enhancement for SCell activation, which can shorten the SCell activation period. The new UE capability may be designed as a unified capability for L3 and/or L1 enhancement, or may be designed as differentiated capabilities for L3 enhancement and/or L1 enhancement. The capability may be designed on per UE basis, on per Band-combination (BC) basis, on Per band per BC basis or on per-FR basis.

In another aspect, specific enhancement on L3 procedure for SCell activation to shorten the SCell activation period is considered, including enhancing AGC handling, using a smaller beam sweeping factor, using a smaller physical layer filtering factor, and/or reusing timing from cell synchronization.

In yet another aspect, specific enhancement on L1 procedure for SCell activation to shorten the SCell activation period is considered, including L1 enhancement for L1-RSRP/beam measurement and/or timing tracking enhancement on TCI.

Capability for L3 and/or L1 Enhancement

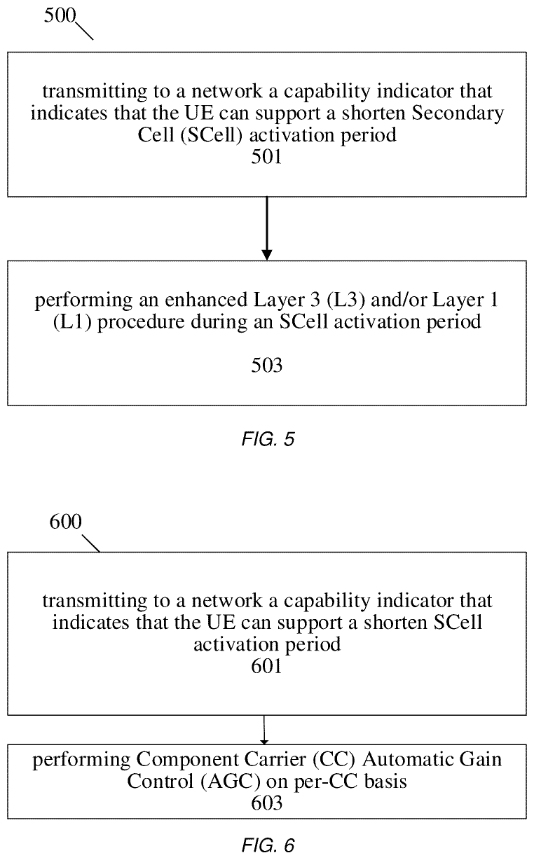

FIG. 5 illustrates an example flowchart of a method 500 performed by a UE, according to embodiments disclosed herein.

As shown in FIG. 5, the method 500 comprise 501, wherein the UE transmits to a network a capability indicator that indicates that the UE can support a shorten Secondary Cell (SCell) activation period.

The method 500 may further comprise 503, where the UE performs an enhanced Layer 3 (L3) and/or Layer 1 (L1) procedure during an SCell activation period.

Although not shown in FIG. 5, the method 500 may comprise generating such a capability indicator at the UE.

In some embodiments, the UE may indicate in the capability indicator a unified capability regarding whether the UE can support SCell activation enhancement, i.e., to support to shorten the SCell activation period, including but not limited to L3 cell synchronization/measurement period, and/or L1 measurement/timing-frequency tracking/(beam measurement (BM) or L1-RSRP) period.

The capability indicator may be included in UE capability Information Element (IE). For example, the capability indicator may be included in MAC parameters or in CA-ParametersNR, as mentioned in TS 38.306. For example, the unified capability indicator may take the form of (FR2-SCellActivationEnh-r18, ENUMERATED {supported}, OPTIONAL).

In some embodiments, the UE may indicate in the capability indicator differentiated capabilities for L3 procedure period and L1 procedure period. In other words, there may be two capability signalings in the capability indicator. One capability signaling may indicate the UE can support to shorten the L3 procedure period during the SCell activation period, including but not limited to L3 cell synchronization/measurement period. The other capability signaling may indicate the UE can support to shorten the L1 procedure period during the SCell activation period, including but not limited to L1 measurement/timing-frequency tracking/(BM or L1-RSRP) period. The two capability signalings may be included in MAC parameters or in CA-ParametersNR, and take the forms of (FR2-SCellActivationEnhL3-r18, ENUMERATED {supported}, OPTIONAL) and (FR2-SCellActivationEnhL1-r18, ENUMERATED {supported}, OPTIONAL) respectively.

The capability of a UE for L3 and/or L1 procedure enhancement for SCell activation may be designed on per UE-basis. That is to say, when a UE indicates this capability, the SCell activation will be enhanced at the UE for any Carrier Aggregate (CA)/Dual Connection (DC) band combination regardless of the number of the activated/deactivated serving CC and the combination of CCs.

In some embodiments, the capability of a UE for L3 and/or L1 procedure enhancement for the SCell activation may be designed on per Band-Combination (BC) basis. For a certain BC, the UE indicates to support this capability, but for other BCs, UE may not support this capability.

In some embodiments, the capability of a UE for L3 and/or L1 procedure enhancement for the SCell activation may be designed on per band per Band-Combination (BC) basis. For a certain band with a certain BC, UE may indicate to support this capability but for other bands and BCs, UE may not support this capability.

In some embodiments, the capability of a UE for L3 and/or L1 procedure enhancement for the SCell activation may be designed on Per-FR basis. That is, the UE can differentiate capabilities for FR2-1 and FR2-2.

### L3 Enhancement-AGC Handling Improvement

FIG. 6 illustrates an example flowchart of a method 600 performed by a UE for enhancement on L3 procedure for SCell activation, according to embodiments disclosed herein.

As shown in FIG. 6, the method 600 may comprise 601, where the UE transmits to the network a capability indicator that indicates that the UE can support a shorten SCell activation period. The capability indicator may indicate the UE can support to shorten the SCell activation period by enhancement on L3 procedure period, e.g., by performing an enhanced L3 procedure.

The method 600 may further comprise 603, where the UE performs Component Carrier (CC) Automatic Gain Control (AGC) on per-CC basis. That is, target CC AGC is estimated on per-CC basis, which means the AGC estimation period is based on the SMTC periodicity or RS periodicity on the CC in question rather than on the max SMTC periodicity or RS periodicity among different serving CCs. For example, in existing SCell activation requirements, T_{FirstSSB_MAX} and T_{SMTC_MAX} is used because the UE needs to perform AGC on the occasion where SMTC or RS among different serving CCs are colliding on time domain. In contrast, by this enhancement, from the perspective of the UE, the AGC on a CC is performed only based on the SMTC periodicity or RS periodicity on this CC, regardless of the SMTC periodicity or RS periodicity on other CCs.

### L3 Enhancement for Cell Synchronization and Measurement

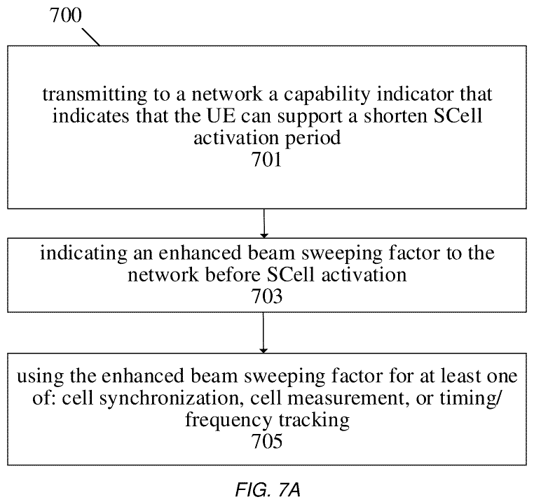

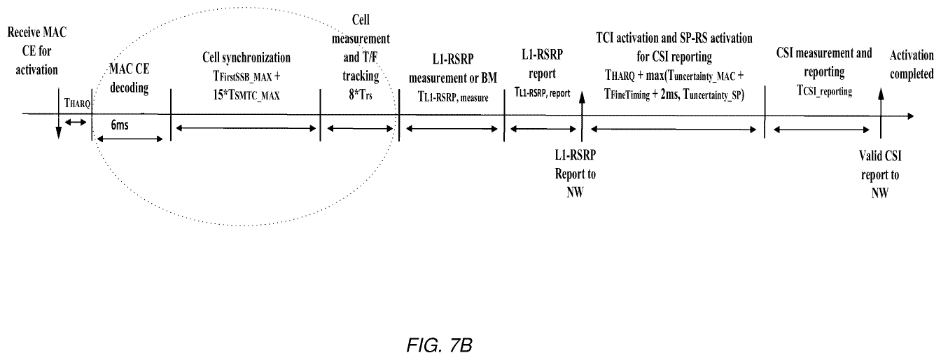

FIG. 7A illustrates an example flowchart of a method 700 performed by a UE for enhancement on L3 procedure for SCell activation, according to embodiments disclosed herein.

As shown in FIG. 7A, the method 700 may comprise 701, where the UE transmits to the network a capability indicator that indicates that the UE can support a shorten SCell activation period. The capability indicator may indicate the UE can support to shorten the SCell activation period by enhancement on L3 procedure period, e.g., by performing an enhanced L3 procedure.

The method 700 may further comprise 703, where the UE may indicate to the network an enhanced beam sweeping factor before SCell activation. The enhanced beam sweeping factor may be smaller than 8. The indication may be sent via RRC or MAC CE. In some embodiments, the UE may indicate that the enhanced beam sweeping factor is applied to at least one of the following: cell synchronization, cell measurement, and/or timing/frequency tracking.

The method 700 may further comprise 705, wherein the UE may use the enhanced beam sweeping factor for at least one of: cell synchronization, cell measurement, or timing/frequency tracking.

FIG. 7B shows an example SCell activation period affected by an enhanced beam sweeping factor, according to embodiments disclosed herein. As can be seen, the enhanced beam sweeping factor may be applied to cell synchronization and/or L3 measurement and/or L3 timing/frequency tracking, as indicted by the dotted circle.

For example, if the enhanced beam sweeping factor is 2 and is applied to the cell measurement and timing/frequency tracking, then the time period associated with the cell measurement and T/F tracking will be changed from 8*Tᵣₛ to 2*Tᵣₛ, resulting in a shorten L3 procedure period. From the network's perspective, the network needs to adjust the timing to schedule reference signals for the following L1 measurement because the network's waiting time for scheduling the reference signals has been changed.

The UE may use a smaller beam sweeping factor from SSB #i to next SSB #i (wherein the SSBs are with the same index #i, and they have the SSB periodicity in between), and the UE may perform beam sweeping among SSB symbols based on the beam sweeping factor.

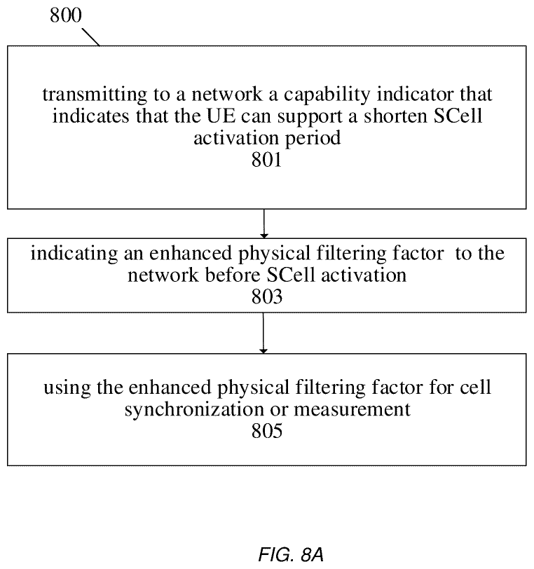

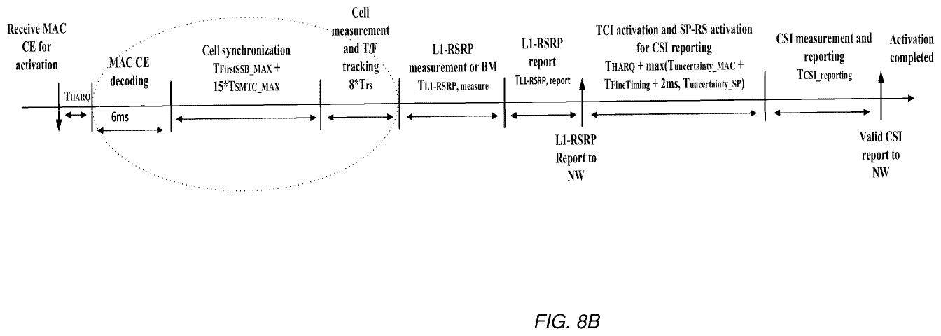

FIG. 8A illustrates an example flowchart of a method 800 performed by a UE for enhancement on L3 procedure for SCell activation, according to embodiments disclosed herein.

As shown in FIG. 8, the method 800 may comprise 801, where the UE transmits to the network a capability indicator that indicates that the UE can support a shorten SCell activation period. The capability indicator may indicate that the UE can support to shorten the SCell activation period by enhancement on L3 procedure period, e.g., by performing an enhanced L3 procedure.

The method 800 may further comprise 803, where the UE may indicate to the network an enhanced physical layer filtering factor before SCell activation. The enhanced physical layer filtering factor may be equal or smaller than 2. The indication may be sent via RRC or MAC CE. The network may schedule the samples sent to the UE for cell synchronization or measurement based on the received enhanced physical layer filtering factor.

The method 800 may further comprise 805, wherein the UE may use the enhanced physical layer filtering factor for cell synchronization or measurement.

FIG. 8B shows an example SCell activation period affected by an enhanced physical layer filtering factor, according to embodiments disclosed herein. As can be seen, the enhanced physical layer filtering factor may be applied to cell synchronization or measurement, resulting in a shorten L3 procedure period.

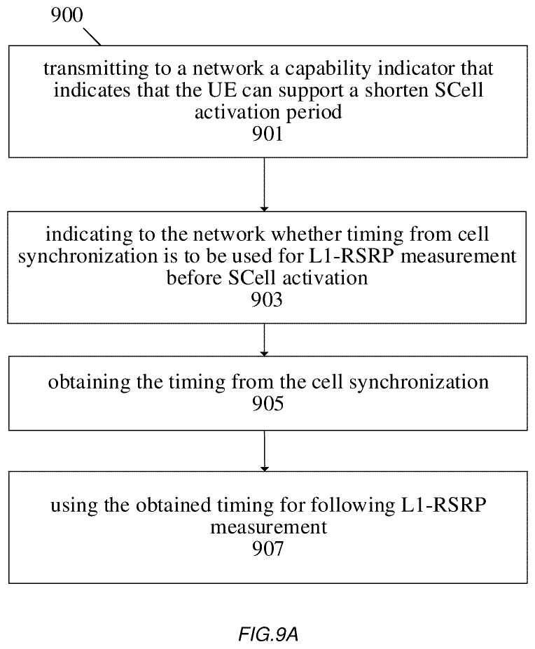

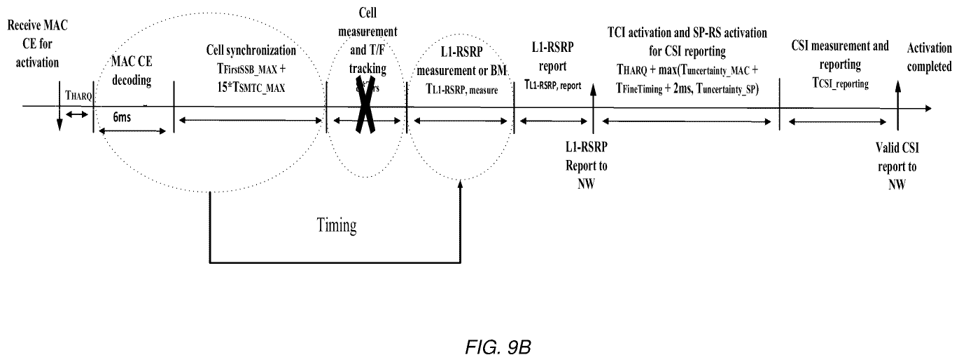

FIG. 9A illustrates an example flowchart of a method 900 performed by a UE for enhancement on L3 procedure for SCell activation, according to embodiments disclosed herein.

As shown in FIG. 9A, the method 900 may comprise 901, where the UE transmits to the network a capability indicator that indicates that the UE can support a shorten SCell activation period. The capability indicator may indicate that the UE can support to shorten the SCell activation period by enhancement on L3 procedure period, e.g., by performing an enhanced L3 procedure.

The method 900 may further comprise 903, where the UE indicates to the network whether timing from cell synchronization is to be used for L1-RSRP measurement before SCell activation. The indication may be sent via RRC or MAC CE. Based on the indication, the network may expect a shorten waiting time to send reference signals for L1-RSRP measurement.

The method 900 may further comprise 905, where the UE obtains the timing from the cell synchronization, e.g., by time domain correlation with local sequences.

The method 900 may further comprise 907, where the UE uses the obtained timing for following L1-RSRP measurement. When the UE obtains and stores the timing from the cell synchronization, it may use the timing directly for the following L1-RSRP measurement rather than L3 Time/Frequency tracking.

As shown in FIG. 9B, the timing from cell synchronization is directly applied to L1-RSRP measurement, and the cell measurement and Time/Frequency tracking before the L1-RSRP measurement can be skipped. Therefore, the L3 procedure period can be shorten.

### L1 Enhancement for L1-RSRP/Beam Measurement

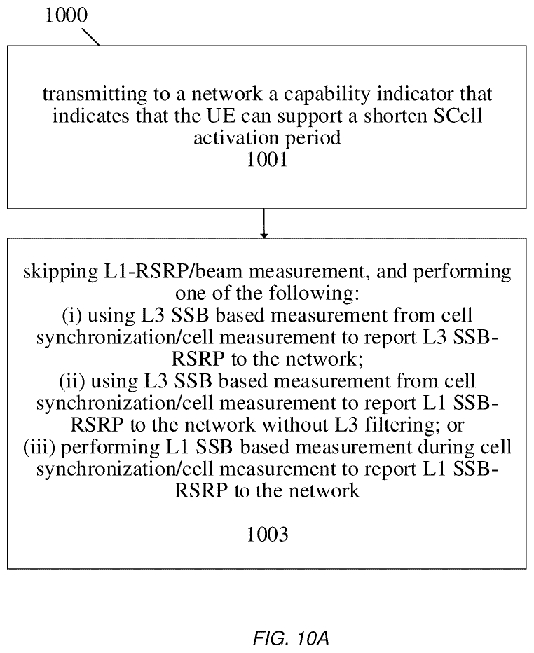

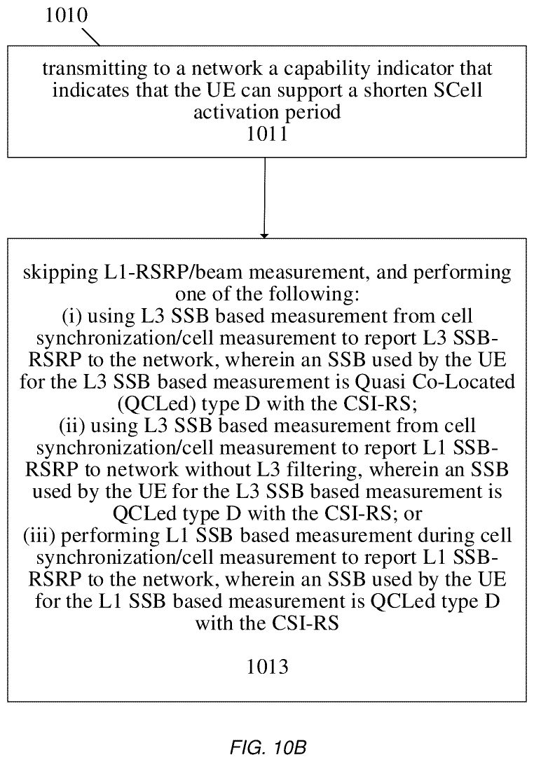

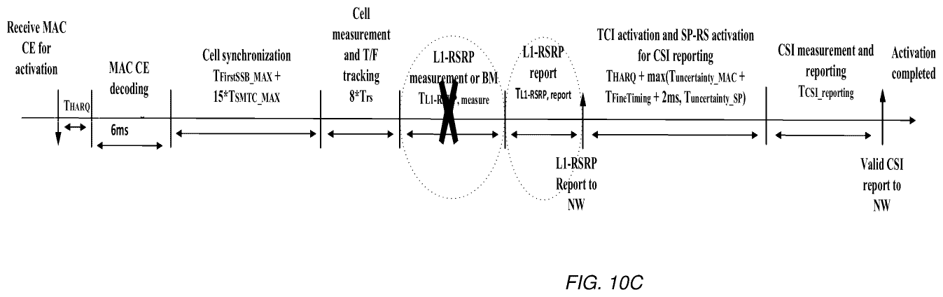

FIG. 10A illustrates an example flowchart of a method 1000 performed by a UE for enhancement on L1 procedure for SCell activation, according to embodiments disclosed herein.

FIG. 10A is related with cases in which a Synchronization Signal and PBCH Block (SSB) is configured as L1-RSRP/beam measurement reference signal (RS). This implies that the beam used for L1 measurement may be the same as that used for L3 measurement, thus measurement results based on SSBs used for L3 measurement may be reused for reporting of L1 measurement.

As shown in FIG. 10A, the method 1000 may comprise 1001, where the UE transmits to the network a capability indicator that indicates that the UE can support a shorten SCell activation period. The capability indicator may indicate that the UE can support to shorten the SCell activation period by enhancement on L1 procedure period, e.g., by performing an enhanced L1 procedure.

The method 1000 may further comprise 1003, where the UE may skip L1-RSRP/beam measurement, and performs one of the following: (i) using L3 SSB based measurement from cell synchronization/cell measurement to report L3 SSB-RSRP to the network; (ii) using L3 SSB based measurement from cell synchronization/cell measurement to report L1 SSB-RSRP to the network without L3 filtering; or (iii) performing L1 SSB based measurement during cell synchronization/cell measurement to report L1 SSB-RSRP to the network.

In some embodiments, when the network configures an SSB as a reference signal for L1-RSRP/beam measurement, L3 SSB based measurement from cell synchronization/cell measurement may be reused to report L3 SSB-RSRP to the network, hence, L1-RSRP/beam measurement can be skipped.

In some embodiments, when the network configures an SSB as a reference signal for L1-RSRP/beam measurement, L3 SSB based measurement from cell synchronization/measurement may be reused to report L1 SSB-RSRP to network without L3 filtering, hence, L1-RSRP/beam measurement can be skipped.

In some embodiments, when the network configures an SSB as a reference signal for L1-RSRP/beam measurement, L3 measurement and L1-RSRP measurement may be performed in parallel during the L3 stage, and L1 SSB based measurement during cell synchronization/measurement (e.g., physical (PHY) measurement with single shot) may be used to report L1 SSB-RSRP to the network, hence, L1-RSRP/beam measurement can be skipped.

FIG. 10B illustrates an example flowchart of a method 1010 performed by a UE for enhancement on L1 procedure for SCell activation, according to embodiments disclosed herein.

FIG. 10B is related with cases in which Channel State Information-Reference Signal (CSI-RS) is configured as L1-RSRP/beam measurement RS.

As shown in FIG. 10B, the method 1010 may comprise 1011, where the UE transmits to the network a capability indicator that indicates that the UE can support a shorten SCell activation period. The capability indicator may indicate that the UE can support to shorten the SCell activation period by enhancement on L1 procedure period, e.g., by performing an enhanced L1 procedure.

The method 1010 may further comprise 1013, where the UE may skip L1-RSRP/beam measurement, and performs one of the following: (i) using L3 SSB based measurement from cell synchronization/cell measurement to report L3 SSB-RSRP to the network, wherein an SSB used by the UE for the L3 SSB based measurement is Quasi Co-Located (QCLed) type D with the CSI-RS; (ii) using L3 SSB based measurement from cell synchronization/cell measurement to report L1 SSB-RSRP to network without L3 filtering, wherein an SSB used by the UE for the L3 SSB based measurement is QCLed type D with the CSI-RS; or (iii) performing L1 SSB based measurement during cell synchronization/cell measurement to report L1 SSB-RSRP to the network, wherein an SSB used by the UE for the L1 SSB based measurement is QCLed type D with the CSI-RS.

In some embodiments, the network configures SSBs for L3 measurement, CSI-RS for L1-RSRP/beam measurement, and the relationship between the SSBs and the CSI-RS (e.g., there is an L3 SSB Quasi Co-Located (QCLed) type D with the CSI-RS), L3 SSB based measurement (i.e., measurement based on the L3 SSB which is QCLed type D with the CSI-RS) from cell synchronization/cell measurement may be reused to report L3 SSB-RSRP to the network, hence, L1-RSRP/beam measurement can be skipped.

In some embodiments, the network configures SSBs for L3 measurement, CSI-RS for L1-RSRP/beam measurement, and the relationship between the SSBs and the CSI-RS (e.g., there is an L3 SSB Quasi Co-Located (QCLed) type D with the CSI-RSs), L3 SSB based measurement (i.e., measurement based on the L3 SSB which is QCLed type D with the CSI-RS) from cell synchronization/measurement may be reused to report L1 SSB-RSRP to network without L3 filtering, hence, L1-RSRP/beam measurement can be skipped.

In some embodiments, the network configures SSBs for L3 measurement, CSI-RS for L1-RSRP/beam measurement, and the relationship between the SSBs and the CSI-RS (e.g., there is an L3 SSB Quasi Co-Located (QCLed) type D with the CSI-RS), L3 measurement and L1-RSRP measurement (based on the L3 SSB which is QCLed type D with the CSI-RSs) may be performed in parallel during the L3 stage, and L1 SSB based measurement during cell synchronization/measurement (e.g., physical (PHY) measurement with single shot) may be used to report L1 SSB-RSRP to the network, hence, L1-RSRP/beam measurement can be skipped.

In these cases as recited with respect to FIG. 10A and FIG. 10B, from the UE's perspective, L1-RSRP/beam measurement can be skipped, as shown in FIG. 10C, resulting in a shorten L1 procedure period. From the network's perspective, the network will shorten its waiting time to schedule TCI activation and SP-RS activation for CSI reporting.

### L1 Enhancement-Timing Tracking Enhancement on TCI

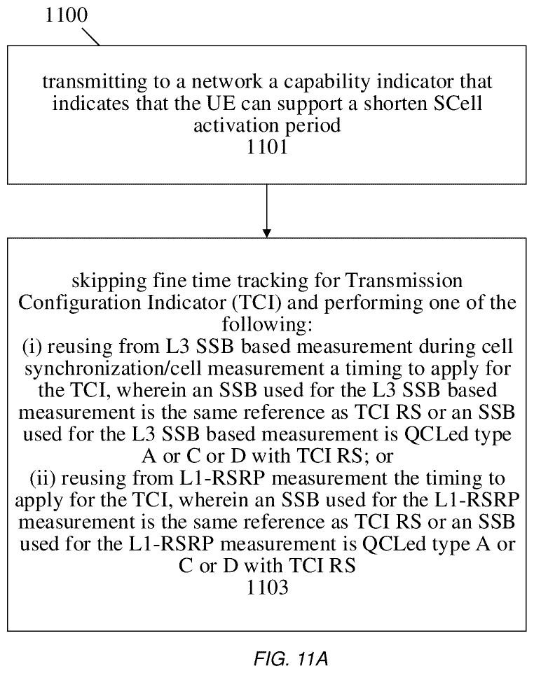

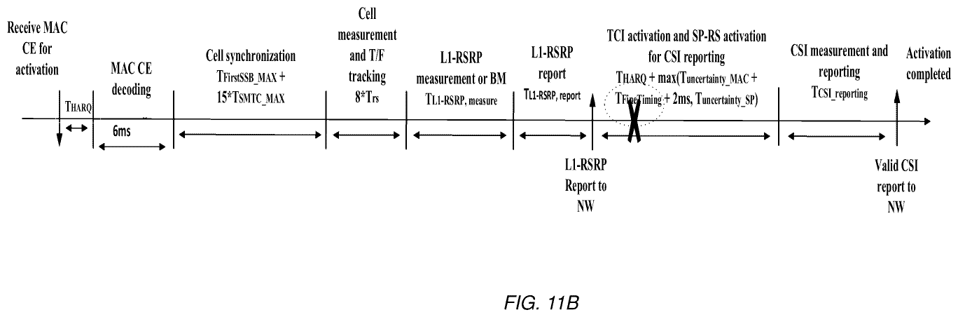

FIG. 11A illustrates an example flowchart of a method 1100 performed by a UE for enhancement on L1 procedure for SCell activation, according to embodiments disclosed herein.

The method 1100 may comprise 1101, where the UE transmits to the network a capability indicator that indicates that the UE can support a shorten SCell activation period. The capability indicator may indicate that the UE can support to shorten the SCell activation period by enhancement on L1 procedure period, e.g., by performing an enhanced L1 procedure.

The method 1100 may further comprise 1103, where the UE skips fine time tracking for Transmission Configuration Indicator (TCI) and performs one of the following: (i) reusing from L3 SSB based measurement during cell synchronization/cell measurement a timing to apply for the TCI, wherein an SSB used for the L3 SSB based measurement is the same reference signal as TCI RS or an SSB used for the L3 SSB based measurement is QCLed type A or C or D with TCI RS; or (ii) reusing from L1-RSRP measurement the timing to apply for the TCI, wherein an SSB used for the L1-RSRP measurement is the same reference signal as TCI RS or an SSB used for the L1-RSRP measurement is QCLed type A or C or D with TCI RS.

In some embodiments, the network configures SSBs for L3 stage, and CTI RS and the relationship between the SSBs and the CTI RS, if an SSB is the same RS as the TCI RS, or if an SSB is QCLed type A or C or D with the TCI RS, the timing to apply for TCI may be reused from L3 SSB based measurement during cell synchronization or measurement, and the UE may skip fine timing tracking for the TCI RS.

In some embodiments, the network configures L1-RSRP/BM RS and CTI RS and the relationship between the L1-RSRP/BM RS and the CTI RS, if the L1-RSRP/BM RS is the same RS as the TCI RS or the L1-RSRP/BM RS is QCLed type A or C or D with the TCI RS, the timing to apply for TCI is reused from L1-RSRP measurement if applicable (if it has L1-RSRP measurement before TCI activation), and the UE may skip fine timing tracking for the TCI RS.

As shown in FIG. 11B, the parameter T_{FineTiming} (and related working part) can be omitted.

Various example enhancements on different working parts during the SCell activation period have been discussed with respect to FIGS. 6-11B. However, those skilled in the art can understand that these various enhancements may be combined. For example, L3 procedure enhancement may be combined with L1 procedure enhancement. Within L3 or L1, different enhancement approaches can also be combined. Those skilled in the art can conceive many variations without departing the teaching of the disclosure.

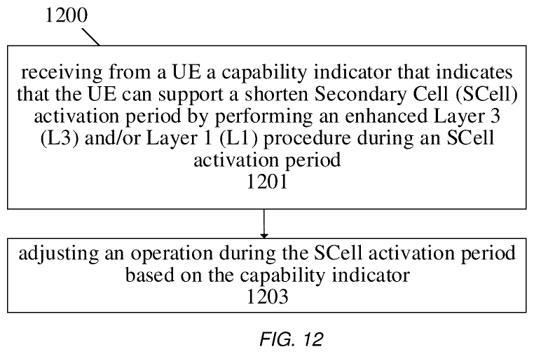

FIG. 12 illustrates an example flowchart of a method 1200 performed by a base station, according to embodiments disclosed herein.

As shown in FIG. 12, the method 1200 may comprise 1201, where the base station receives from a UE a capability indicator that indicates that the UE can support a shorten Secondary Cell (SCell) activation period by performing enhancement on Layer 3 (L3) and/or Layer 1 (L1) procedure during an SCell activation period.

The method 1200 may comprise 1201, where the base station may adjust an operation during the SCell activation period based on the capability indicator. For example, the base station may expect a shorten SCell activation period, may expect shorten waiting time for scheduling some reference signals for the UE.

In some embodiments, the base station may configure reference signals with some specific relationship. For example, the base station may configure L1-RSRP/BM RS and CTI RS and make that the L1-RSRP/BM RS is the same RS as the TCI RS or the L1-RSRP/BM RS is QCLed type A or C or D with the TCI RS. In some embodiments, the base station may configure an SSB as L1-RSRP/beam measurement RS. In some embodiments, the base station may configure SSBs for L3 measurement and CSI-RS for L1-RSRP/beam measurement, with an L3 SSB being Quasi Co-Located (QCLed) type D with the CSI-RS.

In some embodiments, the method may further comprise receiving by the base station at least one of the following from the UE before SCell activation: (i) a beam sweeping factor smaller than 8 for at least one of: cell synchronization, cell measurement, or timing/frequency tracking; (ii) a physical layer filtering factor equal or smaller than 2 for cell synchronization or measurement; or (iii) whether timing from cell synchronization is to be used for L1-RSRP measurement. The information may be received via RRC or MAC CE.

The base station may adjust its operation (e.g., timing of some operations or number of samples) based on the received information. For example, in response to receipt of the smaller beam sweeping factor, the base station may expect a shorten waiting time before scheduling reference signals for L1-RSRP measurement or beam measurement. In response to receipt of the smaller physical layer filtering factor, the base station may expect a shorten waiting time before scheduling reference signals for the following measurement after cell synchronization or measurement. In response to receipt of the indication of timing is to be used for L1-RSRP measurement, the base station may expect a shorten waiting time to schedule reference signals for L1-RSRP measurement or beam measurement.

Embodiments contemplated herein include an apparatus comprising means to perform one or more elements of the method 500, 600, 700, 800, 900, 1000, 1010 and 1100. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 500, 600, 700, 800, 900, 1000, 1010 and 1100. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 500, 600, 700, 800, 900, 1000, 1010 and 1100. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 500, 600, 700, 800, 900, 1000, 1010 and 1100. This apparatus may be, for example, an apparatus of a UE (such as a wireless device 202 that is a UE, as described herein).

Embodiments contemplated herein include a signal as described in or related to one or more elements of the method 500, 600, 700, 800, 900, 1000, 1010 and 1100.

Embodiments contemplated herein include a computer program or computer program product comprising instructions, wherein execution of the program by a processor is to cause the processor to carry out one or more elements of the method 500, 600, 700, 800, 900, 1000, 1010 and 1100. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 1200. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 1200. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 218 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the processor is configured to:
send, to a network, a capability indicator that indicates that the UE supports a reduced Secondary Cell (SCell) activation period; and
perform an enhanced Layer 3 (L3) procedure and/or an enhanced Layer 1 (L1) procedure applying the reduced SCell activation period.

2. The UE of claim 1, wherein the capability indicator is included in UE capability Information Element (IE).

3. The UE of claim 1, wherein the capability indicator is used per UE, per Band Combination (BC), per band of a BC, or per Frequency Range (FR).

4. The UE of claim 1, wherein in order to perform the enhanced L3 procedure during the SCell activation period, the processor is further configured to:
perform Component Carrier (CC) Automatic Gain Control (AGC) on per-CC basis.

5. The UE of claim 1, wherein in order to perform the enhanced L3 procedure during the SCell activation period, the processor is further configured to:
use a beam sweeping factor smaller than 8 for at least one of: cell synchronization, cell measurement, or timing/frequency tracking.

6. The UE of claim 5, wherein the processor is further configured to:
indicate the beam sweeping factor to the network before SCell activation.

7. The UE of claim 1, wherein in order to perform the enhanced L3 procedure during the SCell activation period, the processor is further configured to:
use a physical layer filtering factor equal or smaller than 2 for cell synchronization or measurement.

8. The UE of claim 7, wherein the processor is further configured to:
indicate the physical layer filtering factor to the network before SCell Activation.

9. The UE of claim 1, wherein in order to perform the enhanced L3 procedure during the SCell activation period, the processor is further configured to:
obtain timing from cell synchronization; and
use the obtained timing for following Layer 1-Reference Signal Receiving Power (L1-RSRP) measurement,
wherein cell measurement and time/frequency tracking are skipped.

10. The UE of claim 9, wherein the processor is further configured to:
indicate whether the timing from cell synchronization is to be used for L1-RSRP measurement before SCell activation.

11. The UE of claim 1, wherein a Synchronization Signal and PBCH Block (SSB) is configured as L1-RSRP/beam measurement reference signal (RS), in order to perform the enhanced L1 procedure during the SCell activation period, the processor is further configured to:
skip L1-RSRP/beam measurement, and perform one of the following:
(i) use L3 SSB based measurement from cell synchronization/cell measurement to report L3 SSB-RSRP to the network;
(ii) use L3 SSB based measurement from cell synchronization/cell measurement to report L1 SSB-RSRP to the network without L3 filtering; or
(iii) perform L1 SSB based measurement during cell synchronization/cell measurement to report L1 SSB-RSRP to the network.

12. The UE of claim 1, wherein Channel State Information-Reference Signal (CSI-RS) is configured as L1-RSRP/beam measurement RS, in order to perform the enhanced L1 procedure during the SCell activation period, the processor is further configured to:
skip L1-RSRP/beam measurement, and perform one of the following:
(i) use L3 SSB based measurement from cell synchronization/cell measurement to report L3 SSB-RSRP to the network, wherein an SSB used by the UE for the L3 SSB based measurement is Quasi Co-Located (QCLed) type D with the CSI-RS;
(ii) use L3 SSB based measurement from cell synchronization/cell measurement to report L1 SSB-RSRP to network without L3 filtering, wherein an SSB used by the UE for the L3 SSB based measurement is QCLed type D with the CSI-RS; or
(iii) perform L1 SSB based measurement during cell synchronization/cell measurement to report L1 SSB-RSRP to the network, wherein an SSB used by the UE for the L1 SSB based measurement is QCLed type D with the CSI-RS.

13. The UE of claim 1, wherein in order to perform the enhanced L1 procedure during the SCell activation period, the processor is further configured to:
skip fine time tracking for Transmission Configuration Indicator (TCI) and perform one of the following:
(i) reuse from L3 SSB based measurement during cell synchronization/cell measurement a timing to apply for the TCI, wherein an SSB used for the L3 SSB based measurement is the same reference signal as TCI RS or an SSB used for the L3 SSB based measurement is QCLed type A or C or D with TCI RS; or
(ii) reuse from L1-RSRP measurement the timing to apply for the TCI, wherein an SSB used for the L1-RSRP measurement is the same reference signal as TCI RS or an SSB used for the L1-RSRP measurement is QCLed type A or C or D with TCI RS.

14. A method, comprising:
by a user equipment (UE),
transmitting to a network a capability indicator that indicates that the UE supports a reduced Secondary Cell (SCell) activation period; and
performing an enhanced Layer 3 (L3) and/or Layer 1 (L1) procedure applying the reduced SCell activation period.

15-18. (canceled)

19. A method, comprising:
by a base station (BS),
receiving, from a UE, a capability indicator that indicates that the UE supports a reduced Secondary Cell (SCell) activation period by performing enhancement on Layer 3 (L3) and/or Layer 1 (L1) procedure during an SCell activation period; and
adjusting an operation during the SCell activation period based on the capability indicator.

20-21. (canceled)

22. The method of claim 19, wherein the capability indicator includes a first capability signaling supporting to reduce an L3 procedure period and a second capability signaling supporting to reduce an L1 procedure period.

23. The method of claim 22, wherein the first capability signaling indicates a reduced L3 cell synchronization/measurement period.

24. The UE of claim 1, wherein the capability indicator includes a first capability signaling supporting to reduce an L3 procedure period for the enhanced L3 procedure and a second capability signaling supporting to reduce an L1 procedure period for the enhanced L1 procedure.

25. The UE of claim 24, wherein the first capability signaling indicates a reduced L3 cell synchronization/measurement period.

26. The UE of claim 24, wherein the second capability signaling indicates a reduced Layer 1-Reference Signal Receiving Power (L1-RSRP) measurement or timing-frequency tracking period.
